(19) United States
(12) Patent Application Publication
(10) Pub. No.: US 2011/0138578 A1
(43) Pub. Date: Jun. 16, 2011

(54) COUPLING FOR INDUCING HIGH TEMPERATURE DROPS BETWEEN CONNECTED PARTS ON AN AIRCRAFT

(76) Inventors: Marco Premazzi, Varese (IT); Federico Garuccio, Bresso (IT)

(21) Appl. No.: 12/992,816

(22) PCT Filed: May 1, 2009
(86) PCT No.: PCT/IB09/05471

§ 371 Date: Feb. 28, 2011

(30) Foreign Application Priority Data
May 15, 2008 (IT) MI2008A000886

(51) Int. Cl. B64C 7/00; B64D 29/06; B64C 3/28

(52) U.S. Cl. 16/385; 16/221

(57) ABSTRACT

Coupling for inducing high temperature drops on parts of an aircraft includes an edge portion (2) subjected to high temperature and a bearing structure (3) having limited capacity to resist against high temperatures. The coupling includes at least one hinge (4) having low heat conductivity.

The present invention refers to a coupling for inducing high temperature drops between connected parts on an aircraft, such as for example an engine nacelle or a coupling profile for the wings, comprising an edge portion subjected to high temperature and a bearing structure having limited capacity to resist against high temperatures.

In the aeronautical industry the engine bearing structure or the casing thereof is conventionally referred to as “nacelle”, and it has connected parts one of which is heated and the other has limited capacity to resist against high temperatures.

The aircraft engine nacelle is divided into different parts connected to each other and in particular for the front part, commonly referred to as “engine air inlet”, it comprises an annular inlet profile and a bearing structure or body of the nacelle air inlet.

The input edge profiles of the aircraft engine nacelles are usually protected against formation and or accumulation of ice. Generally, protection systems are of the pneumatic or thermal type. The thermal systems, in particular, are based on the convective heating by means of hot compressed air or on the electrical heating of the surfaces to be protected against ice. The thermal systems are adapted to induce heat to the input edge profile. Such heat generally tends to spread by conduction also to the bearing structure which supports the heated profile, in that, in the systems of the known type, the coupling of the structure of the hot part of the inlet profile with the cold support part is attained by directly joining the two structures to each other.

Generally, the increasing use, regarding aeronautical structures, of composite materials, with limited resistance against exposure to high temperatures, makes such spreading of the heat detrimental.

Thus, the Applicant thought of how to prevent the transfer of heat from an actively heated profile towards the structure bearing the same, i.e. maximise the temperature drop.

The Applicant found a solution to such problem by making a coupling in which the two abovementioned profile parts or edge and bearing structure are, not directly placed at contact with each other, but are connected to each other by means of at least one heat bridge, which represents a mechanical continuity element.

The heat may thus migrate by conduction from the profile structure of the input edge to the support one, only passing through the compulsory path provided for by the heat bridge which is obtained using low heat conductivity materials. Such materials hinder heat transfer by conduction from the hotter part of the coupling to the colder one, increasing, considering the same heat exchange, the temperature drops.

Furthermore, the coupling, if positioned in parts of the nacelle with low aerodynamics turbulence introduces a physical discontinuity of the aerodynamic profile in the part exposed to air, between the profile of the input edge and that of the support structure, due to the presence of the previously illustrated contact discontinuity between the materials. Such discontinuity facilitates and imposes passing from the laminar motion regime to the turbulent motion regime of the air flowing thereabove. The turbulent motion in turn increases heat exchange of the convective type between the air and the surface of the structure downstream of the interruption, actively cooling it.

An aspect of the present invention regards a coupling for inducing high temperature drops on connected parts of an aircraft according to the attached claim 1.

Further aims and advantages of the coupling for inducing high temperature drops between connected parts on an aircraft according to the present invention shall be apparent from the following description and from the attached drawings, provided merely for exemplifying and non-limiting purposes, wherein:

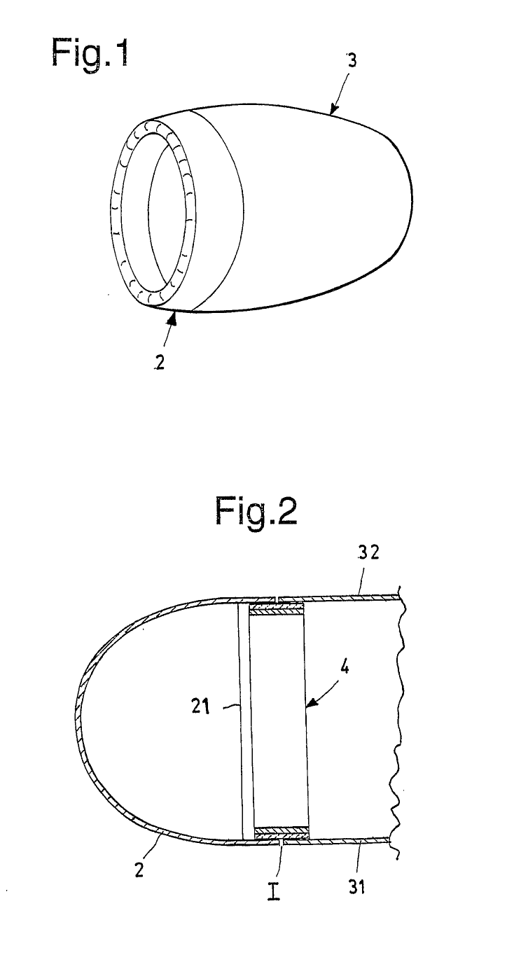

FIG. 1 shows a perspective view of an engine nacelle according to the present invention;

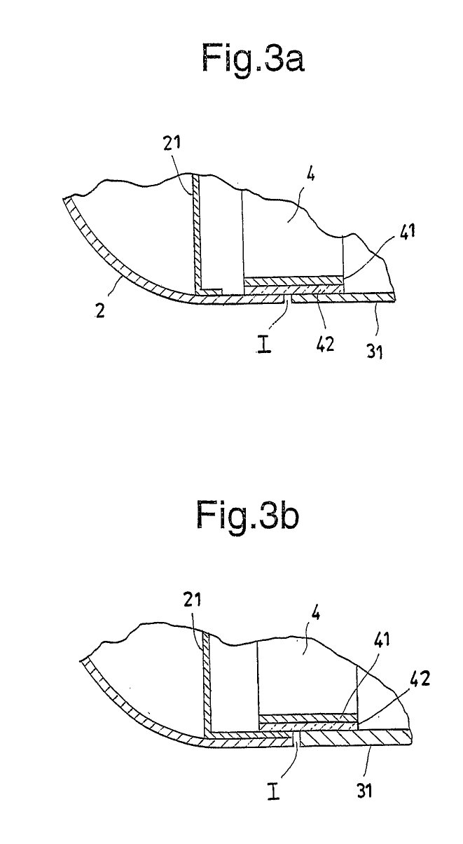

FIG. 3a shows a sectional view of an enlarged detail of the coupling for inducing high temperature drops between parts connected on engine nacelles of FIG. 1 according to a first embodiment of the present invention;

FIG. 3b shows a sectional view of an enlarged detail of the coupling for inducing high temperature drops between connected parts on engine nacelles of FIG. 1 according to a second embodiment of the present invention.

Referring to the abovementioned figures, according to the present invention, the engine nacelle comprises an oblong-shaped casing hollow therein and adapted to contain the turbo-reactor with all the elements thereof, such as for example the turbine, the compressor and the combustion chamber.

Referring to the abovementioned figures, such casing is divided into two parts connected to each other and in particular it comprises an annular edge portion 2 having an extended profile and a bearing structure 3 or nacelle body.

Such edge portion is usually heated to protect it against formation and or accumulation of ice. The heating systems are of the convective or electrical type and they are adapted to provide heat to the profile of such edge portion.

The edge portion further comprises a baffle 21 which contains—at the rear part—the profile of the input edge of the nacelle.

The bearing structure is made up of an external panel 31 and an internal panel 32, which can be for example a sound absorbing panel, the panels being substantially concentric with respect to each other.

According to the present invention, the edge portion and the bearing structure are connected to each other by means of a hinge 4 adapted to determine the mechanical continuity between the profile structure of the input edge and that of the bearing structure, in that the two parts are not directly in contact with each other. Analogously, according to the present invention, other connected parts of the aircraft may be joined to each other by means of one or more of the abovementioned hinges.

Such hinge is preferably made by means of a metal layer 41, for example titanium or a titanium-based alloy, overlapped onto a non-metal layer 42, for example by means of a layer of epoxy glass fibre, in such a manner to obtain an overall hinge having low heat conductivity.

The coefficient of heat conductivity of the materials used for making the hinge are listed in Table A. Table A also provides the heat conductivity value of the aluminium alloy used for manufacturing the input edge of the engine nacelle. Comparing the heat conductivity values of the materials used for manufacturing the hinge with that of the aluminium alloy it shows that:
the heat conductivity of Titanium T50 is lower by one order,
the heat conductivity of the Titanium T6AL4V alloy is lower by two orders,
the heat conductivity of glass fibre is lower by three orders

TABLE A

| | Aluminium | | | |
|---|---|---|---|---|
| | 2219 alloy | | Titanium | |
| | (input | | T6AL4V | |
| Materials | edge) | Titanium T50 | Alloy | Fibreglass |
| Thermal | 170 | 17 | 7 | 0.05 |
| conductivity | | | | |
| W/m K | | | | |
| (in the | | | | |
| temperature | | | | |
| range between | | | | |
| 20° C. and | | | | |
| 100° C.) | | | | |

In practice, the hinge provides a heat bridge that hinders the transfer of heat by conduction from the hotter part of the coupling (input structure) to the colder one (bearing structure), increasing, considering the same heat exchange, the temperature drops.

Furthermore, the heat bridge, if positioned in parts with low aerodynamic turbulence, introduces a physical discontinuity of the aerodynamic profile in the part exposed to air, between the profile of the input edge and that of the bearing structure, due to the presence of the previously illustrated contact discontinuity between the materials. Such discontinuity facilitates and imposes passing from the laminar motion regime to the turbulent motion regime of the air flowing thereabove. The turbulent motion in turn increases the heat exchange of the convective type between the air and the surface of the structure downstream of the interruption, actively cooling it.

According to the present invention, such hinge may be positioned both between the edge 2 and the external panel 31 of the bearing structure and between the edge and the internal panel 32.

Furthermore, in the preferred embodiment of FIG. 3a, the hinge is directly applied to the coupling I between the profile of the input edge and the bearing structure thereof, while in FIG. 3b the hinge is also overlapped onto the baffle 21 for closing such edge.

The epoxy glass fibre layer is preferably made integral with the metal layer made of titanium by means of a process for curing the resin in autoclave or oven. The thicknesses of the hinge (titanium layer and fibre glass layer) are variable depending on the load the structure is required to bear and on the heat flow that the heat bridge is required to reduce.

1. Coupling for inducing high temperature drops on parts of an aircraft comprising an edge portion subjected to high temperature and a bearing structure having limited capacity to resist against high temperatures comprising at least one hinge having low heat conductivity.

2. Coupling according to claim 1, wherein the hinge comprises a metal layer and a non-metal layer.

3. Coupling according to claim 1, wherein the metal layer is a titanium layer or is based on a titanium alloy and the non-metal layer is a glass fiber layer.

4. Coupling according to claim 1, wherein the bearing structure is formed by an external panel and an internal sound absorbing panel, the panels being substantially concentric with respect to each other.

5. Coupling according to claim 4, wherein the edge portion comprises a baffle for closing the edge.

6. Coupling according to claim 4, wherein the hinge may be positioned both between the edge and the external panel of the bearing structure and between the edge and the internal panel.

7. Coupling according to claim 5, wherein the hinge is directly applied to the coupling between the profile of the input edge and the bearing structure thereof and the coupling is capable of causing a perturbation of the aerodynamic motion field between the joined materials.

8. Coupling according to claim 5, wherein the hinge is overlapped onto the baffle for closing the edge.

9. Coupling according to claim 1, which can be positioned at any position of an engine nacelle, and further comprising an aerodynamic disturbance element adapted to cause a perturbation of the aerodynamic motion field between the joined materials.

10. Coupling according to claim 1, wherein the coupling is positioned on the wing coupling profile.
